(19) United States
(12) Patent Application Publication
(10) Pub. No.: US 2026/0190105 A1
(43) Pub. Date: Jul. 2, 2026

(54) TERMINAL DEVICE, NETWORK DEVICE, AND METHOD FOR INDICATING USAGE OF TRANSMISSION OCCASION

(71) Applicant: LENOVO (BEIJING) LIMITED, Beijing (CN)

(72) Inventors: Ruixiang Ma, Beijing (CN); Haipeng Lei, Beijing (CN); Haiming Wang, Beijing (CN)

(21) Appl. No.: 19/131,096

(22) PCT Filed: Feb. 16, 2023
(86) PCT No.: PCT/CN2023/076550

§ 371 Date: May 19, 2025

(51) Int. Cl. H04W 72/115; H04W 72/0446

(52) U.S. Cl. CPC H04W 72/115; H04W 72/0446

(57) ABSTRACT

Embodiments of the present disclosure relate to a solution for indicating a usage of a transmission occasion. In a solution in accordance with the embodiments of the present disclosure, a terminal device comprises a processor and a transceiver coupled to the processor. The processor is configured to: determine a group of transmission occasions (TOs) associated with one or more configured grant (CG) configurations; and transmit, via the transceiver, to a network device, indication information indicating a usage state of at least one TO in the group of TOs. In this way, the terminal device can indicate the network device the usage state of TO such that the network device can adjust subsequent resource allocation to avoid waste of unused TOs, thereby improving the performance of the communication and saving signaling overhead.

### FIELD

Embodiments of the present disclosure generally relate to the field of communication, and in particular to a terminal device, a network device, and a method for indicating a usage of a transmission occasion.

### BACKGROUND

Xtended Reality (XR) technology creates virtual and immersive environments through Augmented Reality (AR), Virtual Reality (VR) and Mixed Reality (MR) technologies, or blends these virtual landscapes and features with the real-world, to enhance user experience in the real-world. Low latency, high reliability, low power consumption, and high capacity are key service requirements for emerging XR applications. The Fifth Generation New Radio (5G NR), as a new global wireless standard after 1G, 2G, 3G, and 4G networks, aims to support XR applications, which, along with Cloud Computing technology, require high throughput and low latency, and have a big packet size and variable packet size.

The 3rd Generation Partnership Project (3GPP) Release 15 (Rel-15) and Release 16 (Rel-16) introduced features that are the basis for specific enhancements to XR. Further, during Release 17 (Rel-17), traffic models for XR and evaluation methodology were discussed. At the 3GPP Technical Specification Group Radio Access Network Working Group 1 (RAN1) Meeting #111 for Release 18 (Rel-18), candidate enhancement techniques for XR capacity improvements were discussed. Meanwhile, more objectives are studied to specify required changes to Configured Grant (CG) enhancements.

### SUMMARY

In general, embodiments of the present disclosure provide a solution for indicating a usage of a transmission occasion.

In a first aspect, there is provided a terminal device. The terminal device comprises a processor and a transceiver coupled to the processor. The processor is configured to: determine a group of transmission occasions (TOs) associated with one or more configured grant (CG) configurations; and transmit, via the transceiver, to a network device, indication information indicating a usage state of at least one TO in the group of TOs.

In a second aspect, there is provided a network device. The network device comprises a processor and a transceiver coupled to the processor. The processor is configured to: determine, via the processor, a group of transmission occasions (TOs) associated with one or more configured grant (CG) configurations; and receive, via the transceiver, from the terminal device, indication information indicating a usage state of the at least one TO in the group of TOs.

In a third aspect, there is provided a method performed by a terminal device. The method comprises: determining a group of transmission occasions (TOs) associated with one or more configured grant (CG) configurations; and transmitting, to a network device, indication information indicating a usage state of at least one TO in the group of TOs.

In a fourth aspect, there is provided a method performed by a network device. The method comprises: determining, a group of transmission occasions (TOs) associated with one or more configured grant (CG) configurations; and receiving from the terminal device, indication information indicating a usage state of the at least one TO in the group of TOs.

In a fifth aspect, there is provided a computer readable medium. The computer readable medium has instructions stored thereon. The instructions, when executed on at least one processor of a device, causing the device to perform the method of the third aspect.

In a sixth aspect, there is provided a computer readable medium. The computer readable medium has instructions stored thereon. The instructions, when executed on at least one processor of a device, causing the device to perform the method of the fourth aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some embodiments will now be described with reference to the accompanying drawings, in which:

FIG. 1 illustrates an example communication system in which some embodiments of the present disclosure can be implemented;

FIG. 2 illustrates a signalling chart illustrating communication process in accordance with some example embodiments of the present disclosure;

FIG. 3A illustrates a schematic diagram of determining a group of TOs from multiple configured CG configurations based on a time domain window in accordance with some example embodiments of the present disclosure;

FIG. 3B illustrates an another schematic diagram of determining a group of TOs from a single configured CG configurations based on a time domain window in accordance with some example embodiments of the present disclosure;

FIG. 3C illustrates a further schematic diagram of determining a group of TOs from multiple configured CG configurations based on a time domain window in accordance with some example embodiments of the present disclosure;

FIG. 3D illustrates a further schematic diagram of determining a group of TOs from a single configured CG configurations based on a time domain window in accordance with some example embodiments of the present disclosure;

FIG. 3E illustrates a further schematic diagram of determining a group of TOs from multiple configured CG configurations based on a time domain window in accordance with some example embodiments of the present disclosure;

FIG. 3F illustrates a further schematic diagram of determining a group of TOs from a single configured CG configurations based on a time domain window in accordance with some example embodiments of the present disclosure;

FIG. 3G illustrates a further schematic diagram of determining a group of TOs based on a time domain window in accordance with some example embodiments of the present disclosure;

FIG. 4A illustrates a schematic diagram of indexed TOs in accordance with some example embodiments of the present disclosure;

FIG. 4B illustrates a schematic diagram of determining a group of TOs from multiple configured CG configurations based on a pre-defined or indicated number of TOs in accordance with some example embodiments of the present disclosure;

FIG. 4C illustrates an another schematic diagram of determining a group of TOs from multiple configured CG configurations based on a pre-defined or indicated number of TOs in accordance with some example embodiments of the present disclosure;

FIG. 4D illustrates a further schematic diagram of determining a group of TOs based on a pre-defined or indicated number of TOs in accordance with some example embodiments of the present disclosure;

FIG. 5 illustrates a flowchart of an example method implemented at a terminal device in accordance with some embodiments of the present disclosure;

FIG. 6 illustrates a flowchart of an example method implemented at a network device in accordance with some embodiments of the present disclosure; and

FIG. 7 illustrates a simplified block diagram of a device that is suitable for implementing embodiments of the present disclosure.

Throughout the drawings, the same or similar reference numerals represent the same or similar elements.

### DETAILED DESCRIPTION

Principles of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below. In the following description and claims, unless defined otherwise, all technical and scientific terms used herein have the same meaning as commonly understood by one of ordinary skills in the art to which this disclosure belongs.

References in the present disclosure to “one embodiment,” “an example embodiment,” “an embodiment,” and the like indicate that the embodiment described may include a particular feature, structure, or characteristic, but it is not necessary that every embodiment includes the particular feature, structure, or characteristic. Moreover, such phrases do not necessarily refer to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” or the like may be used herein to describe various elements, these elements should not be limited by these terms. These terms are only used to distinguish one element from another element. For example, a first element could also be termed as a second element, and similarly, a second element could also be termed as a first element, without departing from the scope of embodiments. As used herein, the term “and/or” includes any and all combinations of one or more of the listed terms. In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

The terminology used herein is for the purpose of describing particular embodiments only and is not intended to be limiting of embodiments. As used herein, the singular forms “a,” “an” and “the” are intended to include the plural forms as well, unless the context clearly indicates otherwise. It will be further understood that the terms “comprises,” “comprising,” “has,” “having,” “includes” and/or “including,” when used herein, specify the presence of stated features, elements, components and/or the like, but do not preclude the presence or addition of one or more other features, elements, components and/or combinations thereof. For example, the term “includes” and its variants are to be read as open terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” Other definitions, explicit and implicit, may be included below.

As used herein, the term “communication network” refers to a network following any suitable communication standards, such as, 5G NR, Long Term Evolution (LTE), LTE-Advanced (LTE-A), Wideband Code Division Multiple Access (WCDMA), High-Speed Packet Access (HSPA), Narrow Band Internet of Things (NB-IoT), and so on. Further, the communications between a terminal device and a network device in the communication network may be performed according to any suitable generation communication protocols, including but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will also be future type communication technologies and systems in which the present disclosure may be embodied. It should not be seen as limiting the scope of the present disclosure to only the aforementioned systems.

As used herein, the term “network device” generally refers to a node in a communication network via which a terminal device can access the network and receive services therefrom. The network device may refer to a base station (BS) or an access point (AP), for example, a node B (NodeB or NB), a radio access network (RAN) node, an evolved NodeB (eNodeB or eNB), a NR NB (also referred to as a gNB), a Remote Radio Unit (RRU), a radio header (RH), an infrastructure device for a V2X (vehicle-to-everything) communication, a transmission and reception point (TRP), a reception point (RP), a remote radio head (RRH), a relay, an integrated access and backhaul (IAB) node, a low power node such as a femto BS, a pico BS, and so forth, depending on the applied terminology and technology.

As used herein, the term “terminal device” generally refers to any end device that may be capable of wireless communications. By way of example rather than limitation, a terminal device may also be referred to as a communication device, user equipment (UE), an end user device, a subscriber station (SS), an unmanned aerial vehicle (UAV), a portable subscriber station, a mobile station (MS), or an access terminal (AT). The terminal device may include, but not limited to, a mobile phone, a cellular phone, a smart phone, a voice over IP (VoIP) phone, a wireless local loop phone, a tablet, a wearable terminal device, a personal digital assistant (PDA), a portable computer, a desktop computer, an image capture terminal device such as a digital camera, a gaming terminal device, a music storage and playback appliance, a vehicle-mounted wireless terminal device, a wireless endpoint, a mobile station, laptop-embedded equipment (LEE), laptop-mounted equipment (LME), a USB dongle, a smart device, wireless customer-premises equipment (CPE), an Internet of Things (IoT) device, a watch or other wearable, a head-mounted display (HMD), a vehicle, a drone, a medical device and application (for example, a remote surgery device), an industrial device and application (for example, a robot and/or other wireless devices operating in an industrial and/or an automated processing chain contexts), a consumer electronics device, a device operating on commercial and/or industrial wireless networks, and the like. In the following description, the terms “terminal device,” “communication device,” “terminal,” “user equipment” and “UE” may be used interchangeably.

As mentioned above, more objectives are studied to specify required changes to CG enhancements in Rel-18. Physical Uplink Shared Channel (PUSCH) transmission can be dynamically scheduled by an Uplink (UL) grant in a Downlink Control Information (DCI), or the PUSCH transmission can correspond to CG Type 1 or Type 2 without dynamic grant. UE would be configured one or multiple CG configurations by network device(s), and the CG configuration indicates the CG type of CG Type 1 or CG Type 2, and a periodicity of the CG configuration.

To satisfy the requirements for high throughput, low latency, big packet size and variable packet size, it has been decided in the 3GPP to configure the UE multiple Transmission Occasions (TOs) for the CG PUSCH transmission within a periodicity of a single CG configuration. The UE can transmit XR packet(s) in all or parts of configured TOs immediately upon the arrival of TO in the CG PUSCH transmission.

Inventor(s) find that because the UE may not occupy or use all of the configured TOs, the number of TOs that are not occupied or used by the UE may be less than the number of all configured TOs. This means that there are some unused or wasted TOs configured in the CG configurations. However, the network device is unaware of a real size of a XR packet and whether the configured TOs are to be used by the UE as well as the number of the used TOs. Therefore, a signaling mechanism regarding TOs configured in CG configurations is to be further studied. Furthermore, the inventor(s) find that it would be advantageous that the UE indicates to the network device the unoccupied or unused TOs that have been configured in the CG configurations. And further, the network device is able to re-allocate the unused TOs for other UEs or other services, which can increase the resource utilization of the wireless system as a whole.

In view of the above findings by the inventor(s) and in order to solve the problems in the traditional solutions, embodiments of the present disclosure provide a solution for indicating a usage of a transmission occasion. For example, both a terminal device and a network device may determine a group of transmission occasions (TOs) associated with one or more configured grant (CG) configurations in a same way. The terminal device may further transmit to the network device, indication information indicating a usage state of at least one TO in the group of TOs. In response to receiving, from the terminal device, the indication information indicating a usage state of the at least one TO in the group of TOs, the network device can learn the usage state of TOs and may further re-allocate the unused TOs for other UEs or other services, or re-allocate the entire TOs including the used TOs or unused TOs to achieve a more optimized signaling design. Through the solution of the present disclosure, a signaling mechanism can be introduced which allows the terminal device to indicate the network device the usage state of TO such that the network device can adjust subsequent resource allocation to avoid waste of unused TOs, thereby improving the performance of the communication. The particular designs on the format of indication information in the present disclosure contributes to save signaling overhead, for example, by adopting limited number of bits to indicate the usage of TOs associated with one or more CG configurations. Principles and implementations of embodiments of the present disclosure will be described in detail below with reference to the figures.

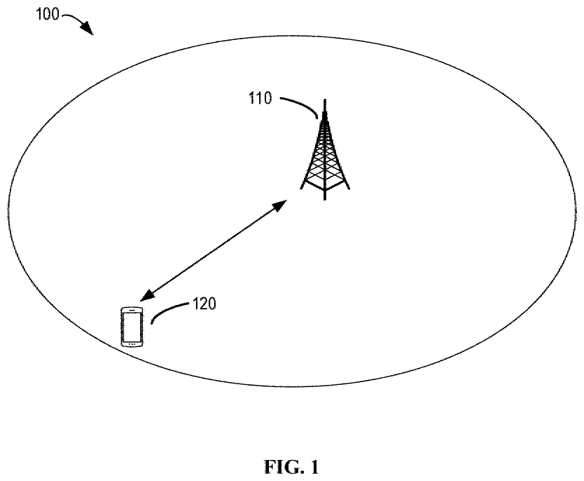

FIG. 1 illustrates an example communication system 100 in which some embodiments of the present disclosure can be implemented. The communication network 100 includes a network device 110 and a terminal device 120. The network device 110 can provide services to the terminal device 120.

In the system 100, it is assumed that the terminal device 120 is located within coverage of the network device 110. In some examples, a link from the network device 110 to the terminal device 120 is referred to as a downlink (DL), while a link from the terminal device 120 to the network device 110 is referred to as an uplink (UL). In downlink, the network device 110 is a transmitting (TX) device (or a transmitter) and the terminal device 120 is a receiving (RX) device (or a receiver). In uplink, the terminal device 120 is a transmitting TX device (or a transmitter) and the network device 110 is a RX device (or a receiver). In some embodiments, the network device 110 and the terminal device 120 may communicate with direct links/channels. DL may comprise one or more logical channels, including but not limited to a Physical Downlink Control Channel (PDCCH) and a Physical Downlink Shared Channel (PDSCH). UL may comprise one or more logical channels, including but not limited to a Physical Uplink Control Channel (PUCCH) and a Physical Uplink Shared Channel (PUSCH). As used herein, the term “channel” may refer to a carrier or a part of a carrier consisting of a contiguous set of resource blocks (RBs) on which a channel access procedure is performed in shared spectrum.

Communications in the system 100, between the network device 110 and the terminal device 120 for example, may be implemented according to any proper communication protocol(s), comprising, but not limited to, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Divided Multiple Address (CDMA), Frequency Divided Multiple Address (FDMA), Time Divided Multiple Address (TDMA), Frequency Divided Duplexer (FDD), Time Divided Duplexer (TDD), Multiple-Input Multiple-Output (MIMO), Orthogonal Frequency Divided Multiple Access (OFDMA) and/or any other technologies currently known or to be developed in the future.

Embodiments of the present disclosure can be applied to any suitable scenarios. For example, embodiments of the present disclosure can be implemented at reduced capability NR devices. Alternatively, embodiments of the present disclosure can be implemented in one of the followings: NR multiple-input and multiple-output (MIMO), NR sidelink enhancements, NR systems with frequency above 52.6 GHz, an extending NR operation up to 71 GHz, narrow band-Internet of Thing (NB-IOT)/enhanced Machine Type Communication (eMTC) over non-terrestrial networks (NTN), NTN, UE power saving enhancements, NR coverage enhancement, NB-IoT and LTE-MTC, Integrated Access and Backhaul (IAB), NR Multicast and Broadcast Services, or enhancements on Multi-Radio Dual-Connectivity.

It is to be understood that the numbers of devices (i.e., the network device 110 and the terminal device 120) and their connection relationships and types shown in FIG. 1 are for the purpose of illustration without suggesting any limitation. The system 100 may include any suitable numbers of devices adapted for implementing embodiments of the present disclosure.

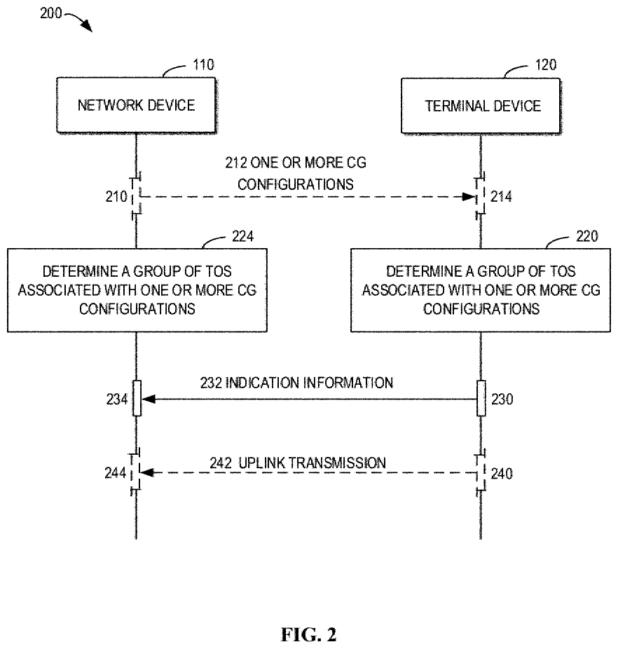

Reference is further made to FIG. 2, which illustrates a signalling chart illustrating communication process 200 in accordance with some example embodiments of the present disclosure. For the purpose of discussion, the process 200 will be described with reference to FIG. 1. The process 200 may involve the network device 110 and the terminal device 120.

The network device 110 transmits 210, to the terminal device 120, one or more CG configurations 212 associated with at least one TO. On the other side of communication, the terminal device 120 receives 214 the one or more CG configurations 212. In some example embodiments, the one or more CG configurations 212 are used for PUSCH transmission, each of which may indicate a CG type, a periodicity, and at least one TO of each CG configuration.

In some example embodiments, the CG type may indicate CG Type 1 wherein an uplink grant is provided by a higher layer parameter in radio resource control (RRC) and stored as configured uplink grant, or CG Type 2, where an uplink grant is provided by physical downlink control channel (PDCCH), and stored or cleared as configured uplink grant based on a signalling indicating configured uplink grant activation or deactivation. In some examples, the CG Type 1 PUSCH transmission is semi-statically configured to operate, without the detection of an UL grant in a DCI, upon the reception of higher layer parameter of configuredGrantConfig including rrc-ConfiguredUplinkGrant. The CG Type 2 PUSCH transmission is semi-persistently scheduled by an UL grant in a valid activation DCI upon the reception of higher layer parameter configuredGrantConfig not including rrc-ConfiguredUplinkGrant.

In some example embodiments, the periodicity may indicate specific time duration of the CG PUSCH transmission. In some examples, the periodicity may be { 1/7 ms, 0.5 ms, 1 ms, . . . , 320 ms, 640 ms} for 15 kHz, 0.5×{ 1/7 ms, 0.5 ms, 1 ms, . . . , 1280 ms} for 30 kHz, 0.25×{ 1/7 ms, 0.5 ms, 1 ms, . . . , 2560 ms} for 60 kHz. In some examples, different CG configurations may have a same periodicity or have different periodicities. It is to be understood that the periodicity may be any value and the present disclosure does not limit this aspect.

In some example embodiments, the TO may refer to a data channel that can be used for user data transmission, for example, the CG PUSCH transmission. For example, a configured TO may occupy multiple time units, where a time unit may be ms, s, a symbol, a slot, a sub-frame, a frame, etc. In some examples, a specific number of TOs may be configured in a CG configuration or located within a periodicity of a CG configuration. It is to be understood that the value of the specific number may be any positive integer and the present disclosure does not limit this aspect.

As shown in FIG. 2, the terminal device 120 may determine 220 a group of TOs associated with the one or more CG configurations 212. On the other side of communication, the network device 110 may determine 224 a group of TOs associated with one or more CG configurations 212, correspondingly. The terminal 120 may transmit 230, to the network device 110, indication information 232 indicating a usage state of at least one TO in the group of TOs. On the other side of communication, the network device 110 may receive 234, from the terminal device 120, the indication information 232 indicating the usage state of the at least one TO in the group of TOs. In the present disclosure, the usage state of TO may indicate the TO is used or unused by the terminal device 120, for example, for the user data transmission of XR services. In some example embodiments, the indication information may be transmitted in one or more uplink control information (UCI) messages. It is to be understood that the present disclosure does not limit the transmission method of the indication information.

The terminal 120 may transmit 240 an uplink transmission 242 to the network device 110. In some examples, the uplink transmission 242 may be a CG PUSCH (or UL-SCH) in at least one TO, which means the at least one TO is used or occupied by the uplink transmission 242 of the terminal device 120. On the other side of communication, the network device 110 receives 244 the uplink transmission 242.

The network device 110 may transmit one or more further CG configurations to the terminal device 120. In some examples, the network device 110 may determine the further one or more CG configurations based on the indication information 232 received from the terminal device 120. It is to be understood that the transmission of the one or more further CG configurations may be before the transmission 240, after the transmission 240 or be overlapped with the transmission 240, and the present disclosure does not limit this aspect.

In some example embodiments, in the determination 220, the terminal device 120 may determine the group of TOs based on a time domain window. In some examples, the terminal device 120 may determine multiple configured TOs associated with the one or more configured CG configurations 212, and the group of TOs is the configured TOs located within the time domain window.

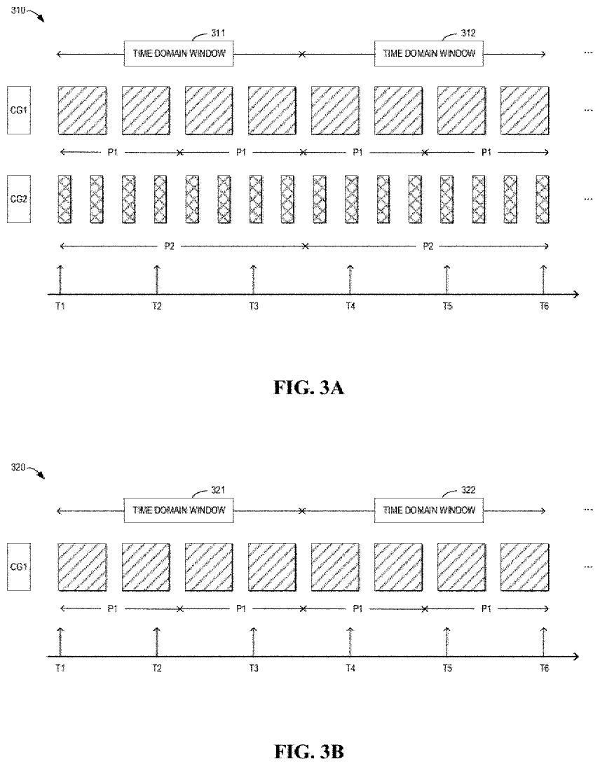

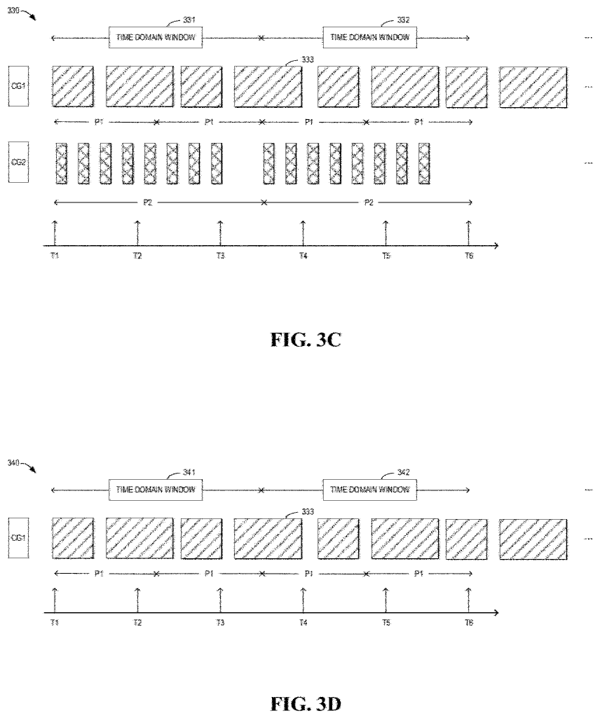

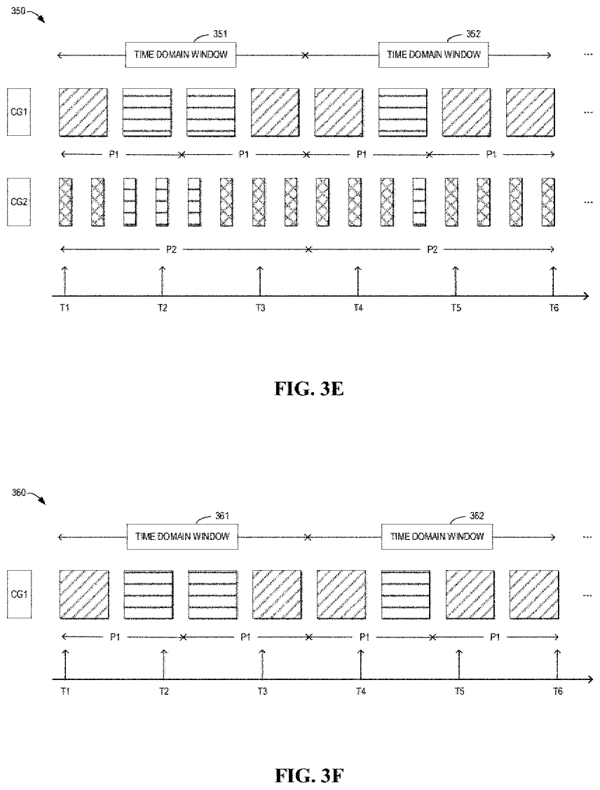

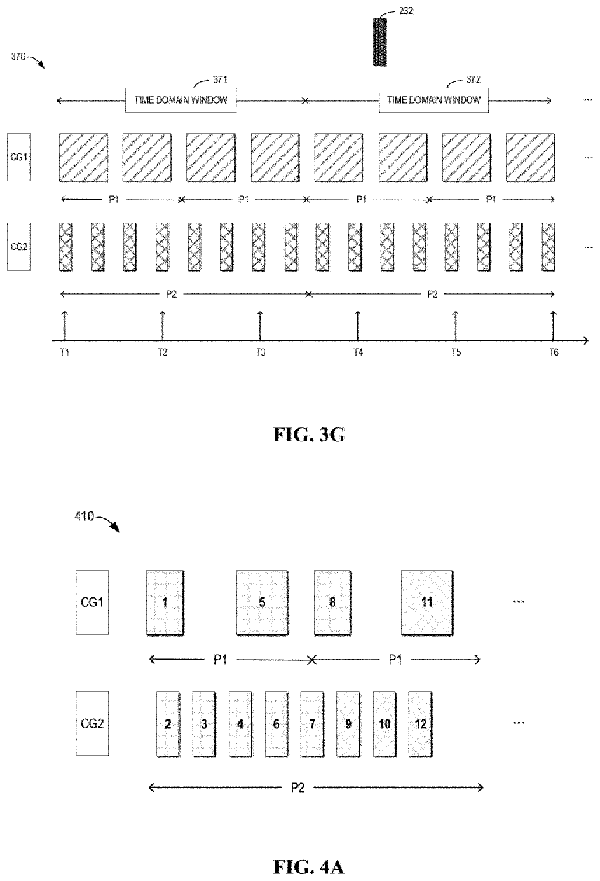

FIG. 3A illustrates a schematic diagram 310 of determining a group of TOs from multiple configured CG configurations based on a time domain window in accordance with some example embodiments of the present disclosure. For example, the network device 110 transmits two CG configurations CG1 and CG2 to the terminal device 120, wherein the CG1 provides two TOs in a single periodicity P1 of CG1, and the CG2 provides eight TOs in a single periodicity P2 of CG2. In the case where the length of a time domain window is equal to P2, and the starting positioning of the time domain window is time T1, the terminal device 120 determines a group of TOs associated with the CG1 and the CG2, in other words, a group of TOs including TO(s) from the CG1 and TO(s) from the CG2, respectively. There is a total number of twelve TOs of the determined group of TOs, including four TOs from CG1 and eight TOs from CG2, within a single time domain window, for example the first time domain window 311, the second time domain window 312, as shown in FIG. 3A.

FIG. 3B illustrates an another schematic diagram 320 of determining a group of TOs from a single configured CG configurations based on a time domain window in accordance with some example embodiments of the present disclosure. For example, the network device 110 transmits a CG configuration CG1 to the terminal device 120, wherein the CG1 provides two TOs in a single periodicity P1 of CG1. In the case where the length of a time domain window is equal to a value twice as much as P1, and the starting positioning of the time domain window is time T1, the terminal device 120 determines a group of TOs associated with the CG1, in other words, a group of TOs including TO(s) from the CG1. There is a total number of four TOs of the determined group of TOs, all of which are from the CG1, within a single time domain window, for example the first time domain window 321, the second time domain window 322, as shown in FIG. 3B.

In some examples, if a configured TO of the multiple configured TOs is cross the time domain window and a next time domain window, the configured TO being counted in one of the time domain window and the next time domain window; or any configured TO of the multiple configured TOs is located within a single time domain window. Specially, the terminal device 120 could be configured multiple TOs, and the terminal device 120 does not expect the starting symbol of a TO is in one time domain window, but the ending symbol of the TO is in another time window. For example, if the starting symbol of a configured TO is in one time window, but the ending symbol of the configured TO is in a different time window, then the TO is counted in the time domain window of the starting symbol or ending symbol.

FIG. 3C illustrates a further schematic diagram 330 of determining a group of TOs from multiple configured CG configurations based on a time domain window in accordance with some example embodiments of the present disclosure. For example, the network device 110 transmits two CG configurations CG1 and CG2 to the terminal device 120, wherein the CG1 provides two TOs in a single periodicity P1 of CG1, and the CG2 provides eight TOs in a single periodicity P2 of CG2. In the case where the length of a time domain window is equal to P2, and the starting positioning of the time domain window is time T1, the terminal device 120 determines a group of TOs associated with the CG1 and the CG2, in other words, a group of TOs including TO(s) from the CG1 and TO(s) from the CG2, respectively. In the case of FIG. 3C, the last TO 333 of the TOs from the CG1 is across the first time domain window 331 and the second time domain window 332, then the last TO 333 is counted in the time domain window 331. As such, there is a total number of eleven TOs of the determined group of TOs, including three TOs from CG1 and eight TOs from CG2, within the time domain window 331.

FIG. 3D illustrates a further schematic diagram 340 of determining a group of TOs from a single configured CG configurations based on a time domain window in accordance with some example embodiments of the present disclosure. For example, the network device 110 transmits a CG configuration CG1 to the terminal device 120, wherein the CG1 provides two TOs in a single periodicity P1 of CG1. In the case where the starting positioning of the time domain window is time T1, the terminal device 120 determines a group of TOs associated with the CG1, in other words, a group of TOs including TO(s) from the CG1. In the case of FIG. 3D, the last TO 333 of the TOs from the CG1 is across the first time domain window 331 and the second time domain window 332, then the last TO 333 is counted in the time domain window 331. As such, there is a total number of three TOs of the determined group of TOs, all of which are from the CG1, within the time domain window 331.

In some examples, the terminal device 120 may transmit indication information indicating a usage state of valid TO(s) in the group of TOs; or transmit indication information indicating a TO is unused, if the TO is invalid; or determine that the group of TOs only includes valid TO(s); wherein a TO is invalid if the TO is overlapped with a common downlink symbol, a dedicated downlink symbol, or a symbol for Synchronization Signal/Physical Broadcast Channel block (SSB). For example, the common downlink symbol may be a downlink symbol configured by Time Division Duplexing Common Downlink Symbol indicated by tdd-UL-DL-ConfigurationCommon, the dedicated downlink symbol may be a downlink symbol configured by Time Division Duplexing Common Downlink Symbol indicated by tdd-UL-DL-ConfigurationDedicated, and the symbols indicated by ssb-PositionsInBurst in System Information Block Type 1 (SIB1) or ssb-PositionsInBurst in ServingCellConfigCommon for reception of SS/PBCH blocks.

FIG. 3E illustrates a further schematic diagram 350 of determining a group of TOs from multiple configured CG configurations based on a time domain window in accordance with some example embodiments of the present disclosure. For example, the network device 110 transmits two CG configurations CG1 and CG2 to the terminal device 120, wherein the CG1 provides two TOs in a single periodicity P1 of CG1, and the CG2 provides eight TOs in a single periodicity P2 of CG2. In the case where the length of a time domain window is equal to P2, and the starting positioning of the time domain window is time T1, the terminal device 120 determines a group of TOs associated with the CG1 and the CG2, in other words, a group of TOs including TO(s) from the CG1 and TO(s) from the CG2, respectively. In the case of FIG. 3E, the second and third TOs from the CG1 and the third to fifth TOs from the CG2 in the first time domain 341 are overlapped with a common/dedicated downlink symbol, or SSB. As such, there is a total number of seven TOs of the determined group of TOs, including three TOs from CG1 and five TOs from CG2, within the time domain window 351.

FIG. 3F illustrates a further schematic diagram 360 of determining a group of TOs from a single configured CG configurations based on a time domain window in accordance with some example embodiments of the present disclosure. For example, the network device 110 transmits a CG configuration CG1 to the terminal device 120, wherein the CG1 provides two TOs in a single periodicity P1 of CG1. In the case where the length of a time domain window is equal to a value twice as much as P1, and the starting positioning of the time domain window is time T1, the terminal device 120 determines a group of TOs associated with the CG1, in other words, a group of TOs including TO(s) from the CG1. In the case of FIG. 3F, the second TO from the CG1 in the first time domain 341 is overlapped with a common/dedicated downlink symbol, or SSB. As such, there is a total number of three TOs of the determined group of TOs, all of which are from the CG1, within a single time domain window.

In some examples, the length of the time domain window is based on a periodicity associated with the one or more CG configurations 212. In some examples, the length of the time domain window is equal to: (1-1) a periodicity of one of the one or more CG configurations; (1-2) a periodicity of a single CG configuration, the group of TOs being associated with the single CG configuration; (1-3) a maximum periodicity among the one or more CG configurations; or (1-4) a maximum periodicity among one of a plurality of groups divided from the one or more CG configurations, each of the plurality of groups comprising at least one CG configuration from the one or more CG configurations. In some examples, the terminal device 120 may identify, based on at least one of a CG configuration index or a group index, that a plurality of CG configurations of the one or more CG configurations are in a same group of the plurality of groups. In some examples, a length of the time domain window is indicated by the network device 110 separately from the periodicity of the CG configuration. In some examples, the length of the time domain window can be in a time unit of ms, s, symbol, slot, sub-frame, frame, etc.

In some examples, the time domain window is based on a time domain position of the indication information. In some examples, a starting positioning of the time domain window is: a time domain position being the N-th time unit after a starting positioning or an ending positioning of the indication information, wherein N is a positive integer. For example, if the indication information is transmitted in symbol #n and N is 1, the starting symbol in time domain is symbol #n+1. For another example, if the indication information is transmitted in symbol #n and N is X, the starting symbol in time domain is symbol #n+X.

In some examples, the time domain window is a time domain window in which the indication information is transmitted, among a plurality of time domain windows. In some examples, the plurality of time domain windows are continuous in time domain, and the starting positioning of the earliest time domain window among the plurality of time domain windows is one of the following: (2-1) a positioning indicated by the network device; (2-2) a pre-defined positioning; (2-3) a starting positioning of the earliest periodicity or the earliest TO of the one or more CG configurations; or (2-4) a starting positioning of the earliest periodicity or the earliest TO of one of a plurality of groups divided from all of the one or more CG configurations, each of the plurality of groups comprising at least one CG configuration from the one or more CG configurations. For example, in the above-mentioned case (2-2), the starting positioning of the earliest time domain window can be defined as a sequence of symbol 0 in slot 0 of sub-frame 0 in frame 0 in the 3GPP specifications. For example, in the above-mentioned case (2-3) or (2-4), if four CG configurations CG1, CG2, CG3 and CG4 are provided, and the earliest TO of CG1 is in slot #2, and the earliest TO of CG2 is in slot #1, the earliest TO of CG3 is in slot #4, the earliest TO of CG4 is in slot #5, then the starting symbol of the earliest time domain window is the starting symbol of slot #1.

FIG. 3G illustrates a further schematic diagram 370 of determining a group of TOs based on a time domain window in accordance with some example embodiments of the present disclosure. For example, the network device 110 transmits two CG configurations CG1 and CG2 to the terminal device 120, wherein the CG1 provides two TOs in a single periodicity P1 of CG1, and the CG2 provides eight TOs in a single periodicity P2 of CG2. The length of a time domain window is equal to P2, the starting positioning of the earliest time domain window among the plurality of time domain windows is determined based on any embodiment of the above-mentioned cases (2-1) to (2-3), the plurality of time domain windows are continuous in time domain. The indication information is transmitted within the second time domain window 372. In such case, the terminal device 120 determines a group of TOs associated with the CG1 and the CG2 within the second time domain window 372, respectively. As such, there is a total number of twelve TOs of the determined group of TOs, including four TOs from the CG1 within the second time domain window 372 and eight TOs from the CG2 within the second time domain window 372.

In some example embodiments, in the determination 220, the terminal device 120 may determine the groups of TO based on a pre-defined or indicated number of TOs. In some examples, the terminal device 120 may determine multiple configured TOs associated with the one or more CG configurations, and the multiple configured TOs are indexed in a pre-defined order. In some examples, the pre-defined order comprises at least one of the following: (3-1) an increasing order of a starting position or an ending position in time domain; (3-2) an increasing order of CG configuration index of the one or more CG configurations; (3-3) an increasing order of a length of TO; or (3-4) an increasing order of frequency domain resource block index of TO. It is understood that these orders of the indexed TOs are for example without suggesting any limitation, and these orders can also be combined in any sequence and in any number.

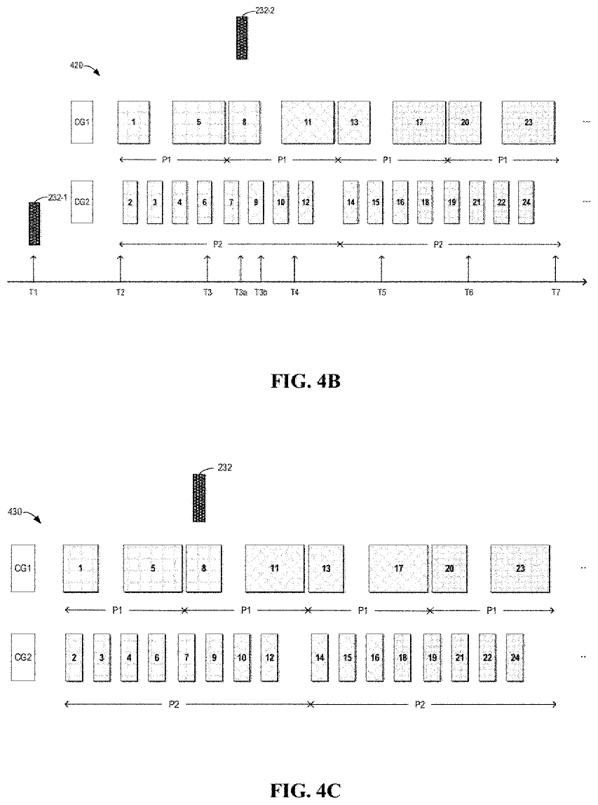

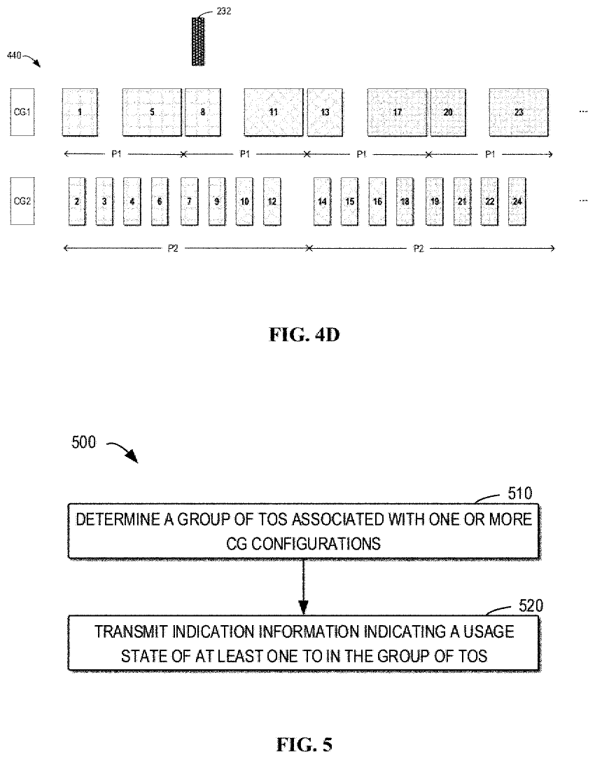

FIG. 4A illustrates a schematic diagram 410 of indexed TOs in accordance with some example embodiments of the present disclosure. For example, the network device 110 transmits two CG configurations CG1 and CG2 to the terminal device 120, wherein the CG1 provides two TOs in a single periodicity P1 of CG1, and the CG2 provides four TOs in a single periodicity P2 of CG2. The TOs in the CG1 and the CG2 are indexed in an increasing order of a starting position in time domain, and the increasing order of CG configuration index for the same starting position. In some examples, the position can be in a time unit of ms, s, symbol, slot, sub-frame, frame, etc.

In some examples, the earliest TO in the group of the TOs is based on a time domain position in which the indication information is transmitted. In some examples, the earliest TO in the group of TOs is one of: (4-1) the N-th time unit after the time domain position in which the indication information is transmitted, wherein N is a positive integer; or (4-2) the earliest TO subsequent to the N-th time unit after the time domain position in which the indication information is transmitted, wherein N is a positive integer. For example, in the above-mentioned case (4-1), if the indication information is transmitted in symbol #n and N is 1, the earliest TO of the group of TOs is symbol #n+1, and if the indication information is transmitted in symbol #n and N is X, the earliestTO of the group of TOs is symbol #n+X. For another example, in the above-mentioned case (4-2), if the indication information is transmitted in TO #n and N is 1, the earliestTO of the group of TOs is TO #n+1, and if the indication information is transmitted in TO #n and N is X, the earliest TO of the group of TOs is TO #n+X.

FIG. 4B illustrates a schematic diagram 420 of determining a group of TOs from multiple configured CG configurations based on a pre-defined or indicated number of TOs in accordance with some example embodiments of the present disclosure. For example, the network device 110 transmits two CG configurations CG1 and CG2 to the terminal device 120, wherein the CG1 provides two TOs in a single periodicity P1 of CG1, and the CG2 provides four TOs in a single periodicity P2 of CG2. In the case where the pre-defined or indicated number of TOs is eight, and the earliest TO of the earliest group of TOs is time T2 which is after the time domain position in T1 in which the indication information 232-1 is transmitted based on the above-mentioned (4-1), the terminal device 120 determines the first group of TOs associated with the CG1 and the CG2, in other words, a group of TOs including TO(s) from the CG1 and TO(s) from the CG2, respectively. There is a total number of eight TOs of the determined group of TOs, including the first eight TOs from the CG1 and the CG2 starting from time T2. Then, in the case where the second TO of the second group of TOs is time T3b which is after the time domain position in T3a in which the next indication information 232-2 is transmitted, the terminal device 120 determines the second group of TOs associated with the CG1 and the CG2, in other words, a group of TOs including TO(s) from the CG1 and TO(s) from the CG2, respectively. There is a total number of eight TOs of the determined group of TOs, including the second eight TOs from the CG1 and the CG2 starting from time T3b.

FIG. 4C illustrates an another schematic diagram 430 of determining a group of TOs from multiple configured CG configurations based on a pre-defined or indicated number of TOs in accordance with some example embodiments of the present disclosure. For example, the network device 110 transmits two CG configurations CG1 and CG2 to the terminal device 120, wherein the CG1 provides two TOs in a single periodicity P1 of CG1, and the CG2 provides four TOs in a single periodicity P2 of CG2. In the case where the pre-defined or indicated number of TOs is eight, and the earliest TO of the earliest group of TOs is TO #10 which is the earliest TO after the time domain position in which the indication information is transmitted based on the above-mentioned (4-2), the terminal device 120 determines the first group of TOs associated with the CG1 and the CG2, in other words, a group of TOs including TO(s) from the CG1 and TO(s) from the CG2, respectively. There is a total number of eight TOs of the determined group of TOs, including the first eight TOs from the CG1 and the CG2 starting from time TO #10.

In some examples, the group of TOs is a group of TOs in which the indication information is transmitted, among a plurality of continuous groups of TOs. In some examples, the earliest TO of the earliest group of TOs among the plurality of continuous groups of TOs is one of the following: (5-1) a TO indicated by the network device; (5-2) a pre-defined TO; (5-3) the earliest TO of the one or more CG configurations; or (5-4) the earliest TO of one of a plurality of groups divided from all of the one or more CG configurations, each of the plurality of groups comprising at least one CG configuration from the one or more CG configurations. For example, in the above-mentioned case (5-2), the earliest TO of the earliest group of TOs can be defined as a sequence of symbol 0 in slot 0 of sub-frame 0 in frame 0 in the 3GPP specifications. For example, in the above-mentioned case (5-3) or (5-4), if four CG configurations CG1, CG2, CG3 and CG4 are provided, and the earliest TO of CG1 is in slot #2, and the earliest TO of CG2 is in slot #1, the earliest TO of CG3 is in slot #4, the earliest TO of CG4 is in slot #5, then the earliest TO of the earliest group of TOs is the earliest TO #1.

FIG. 4D illustrates a further schematic diagram 440 of determining a group of TOs based on a pre-defined or indicated number of TOs in accordance with some example embodiments of the present disclosure. For example, the network device 110 transmits two CG configurations CG1 and CG2 to the terminal device 120, wherein the CG1 provides two TOs in a single periodicity P1 of CG1, and the CG2 provides four TOs in a single periodicity P2 of CG2. The pre-defined or indicated number of TOs is eight, the earliest TO of the earliest group of TOs among the plurality of continuous groups of TOs is determined based on any embodiment of the above-mentioned cases (5-1) to (5-4). The indication information is transmitted at TO #8. In such case, the terminal device 120 determines a group of TOs associated with the CG1 and the CG2 from the group of TOs in which the TO #8 is, respectively. As such, the determined group of TOs is eight TOs from TO #1 to TO #8.

In some examples, the terminal device 120 may transmit indication information indicating a usage state of valid TO(s) in the group of TOs; or transmit indication information indicating a TO is unused, if the TO is invalid; or determine that the group of TOs only includes valid TO(s); wherein a TO is invalid if the TO is overlapped with a common downlink symbol, a dedicated downlink symbol, or a symbol for Synchronization Signal/Physical Broadcast Channel block (SSB). For example, the common downlink symbol may be a downlink symbol configured by Time Division Duplexing Common Downlink Symbol indicated by tdd-UL-DL-ConfigurationCommon, the dedicated downlink symbol may be a downlink symbol configured by Time Division Duplexing Common Downlink Symbol indicated by tdd-UL-DL-ConfigurationDedicated, and the symbols indicated by ssb-PositionsInBurst in System Information Block Type 1 (SIB1) or ssb-PositionsInBurst in ServingCellConfigCommon for reception of SS/PBCH blocks.

In some example embodiments, as a first embodiment of the number of bits of the indication information, the number of bits of the indication information is indicated by the network device 110. For example, the network device could indicate the number of bits of the indication information is 4 bits.

In some examples, as a second embodiment of the number of bits of the indication information, the number of bits of the indication information is based on a set of values configured by the network device, wherein a value indicates a number of unused TOs. In some examples, if the number of values in the set of values is N, then the number of bits of the indication information may be ┌log₂(N)┐. For example, if a set of eight values {1,2,3,4,8,10,12,16} is configured, then the number of bits of the indication information is 3 bits, for example, by a determination based on ┌log₂(8)┐. In some examples, the set of values includes at least one negative value, a negative value indicating a necessary number of TO or indicating that TO is not enough. For example, if a set of eight values {−1,1,2,3,4,8,10,16} is configured, then the number of bits of the indication information is 3, for example, by a determination of ┌log₂(8)┐, wherein the negative value K means |K| TO(s) is needed or means resource for user data transmission is not enough. For example, the negative value K being −1 means that 1 TO is needed or means resource for user data transmission is not enough.

In some example embodiments, as a third embodiment of the number of bits of the indication information, the number of bits of the indication information is based on a number of TOs in the group of TOs. For example, if the number of TOs is M, then the number of bits of the indication information may be ┌log₂(M)┐. As a fourth embodiment of the number of bits of the indication information, the number of bits of the indication information is based on a maximum number of the TOs in all the time domain windows. For example, if the number of TOs in the first time domain window and other time windows is M1, the number of TOs in the second time window is M2, and M2 is greater than M1, then the number of bits of the indication information is ┌log₂(M2)┐.

In some example embodiments, as a fifth embodiment of the number of bits of the indication information, the number of bits of the indication information is based on a number of remaining TOs subsequent to the information indication in the group of TOs. In some examples, if a number of remaining TOs subsequent to the information indication in the group of TOs is N, then the number of bits of the indication information may be ┌log₂(N)┐. For example, if the number of TOs is 8 in a single time window, and the indication information is transmitted in the fourth time window, then the number of bits of the indication information is 2, for example, by a determination of ┌log₂(8−4)┐.

In some example embodiments, the indication information may, based on any of the first to fifth embodiments of the number of bits of the indication information as described above, indicate a number K indicating the usage state of the first K TOs or the last K TOs in the group of TOs, wherein K is a positive integer. In some examples, the number of K is expressed by the number of bits of the indication information. For example, for the case as shown in FIG. 3A where a total number of TOs is twelve in a single time domain window, the number of bits of the indication information is 4 based on a number of TOs in the group of TOs, and the number of K is 4 to indicate the usage state (unused or used) of the first K TOs or the last K TOs in the group of TOs. In some examples, if the number of bits of the indication information is not enough to indicate all the TOs, all of the TOs may be divided into multiple sub-groups, each sub-group indicating a same usage state, and the indication information indicates the usage state for each of the multiple sub-groups.

In some example embodiments, the indication information may, based on the first, third or fourth embodiment of the number of bits of the indication information as described above, be a bitmap, each bit of the bitmap indicating the usage state of a TO or sub-group of the TOs in the group of the TOs. In some examples, the group of TOs may be divided into N sub-groups of the TOs, and each bit has one to one mapping with one of the N sub-groups of the TOs.

As a non-limiting example of determining N sub-groups of the TOs, a group of TOs in a single time domain window can be divided into N sub-groups evenly. For example, if the total number of the TOs in the group of TOs is M, then there can be

$$⌊ \frac{M}{N} ⌋$$

TOs in the first sub-group to the N−1th sub-group, and

$$N - ( N - 1 ) ⌊ \frac{M}{N} ⌋$$

TOs in the Nth sub-group.

As a non-limiting example of determining N sub-groups of the TOs, a group of TOs in a single time domain window can be divided into N sub-groups based on whether there are overlapping among the group of TOs by the following Steps 0 to Step 2, wherein the number N is determined based on the number of TOs and the results of the following Steps 0 to Step 2.
Step 0: Sum M TOs as a group of TOs;
Step 1: Find a first TO among the M TOs with smallest last OFDM symbol, wherein TOs with starting symbol less than or equal to the smallest last OFDM symbol (the overlapped one with the first TO including the first TO) are belong to a TO sub-group; and
Step 2: Assume remaining TOs as the M TOs, and perform Step 1 until to all the TOs in M TOs are sub-grouped.

In such case, the number of bits is equal to N, which indicates the number of sub-groups.

In some example embodiments, the indication information may indicate, based on any of the third to fifth embodiments of the number of bits of the indication information as described above, a starting index of TO and an ending index of TO, to indicate the usage state of TOs from the starting index of TO the ending index of TO. For example, if the starting index of TO is TO #i and the ending index of TO is TO #j, then the indication information may indicate that TOs from TO #i to TO #j are unused. Alternatively, the indication information indicates a starting index of TO and a number of TOs, to indicate the usage state of TOs with the number of TOs from the starting index of TO. For example, if the starting index of TO is TO #i and the number of TOs is X, then the indication information may indicate that TOs from TO #i to TO #+X are unused. In some example embodiments, if the number of the remaining or maximum TOs is M, then the number of bits can be a value based on ┌log₂(M*(M−1)/2)┐.

In some example embodiments, the indication information may include a plurality of fields, each of the plurality of fields corresponding to each of the one or more CG configurations and indicating the usage state of the TO in the corresponding CG configuration. For example, the number of bits for each field may be determined based on the first, third to fifth embodiment of the number of bits of the indication information as described above by replacing the indication information to the field and replacing the group of TOs to the group of TO associated with the CG configurations corresponding to the fields. In some examples, the fields in the indication information correspond to an increasing order of CG configuration index. For example, in the case as showed in FIG. 3A, there are two CG configurations CG1 and CG2, and four TOs from the CG1 and eight TOs from the CG2 within in a single time domain window, then the number of fields can be 2, the number of bits of the field corresponding to the CG1 is 2 based on a number of TOs from the CG1 in the group of TOs by a determination based on ┌log₂(4)┐, and the number of bits of the field corresponding to the CG2 is 3 based on a number of TOs from the CG2 in the group of TOs by a determination based on ┌log₂(8)┐. As such, the fields in the indication information correspond to an order of first CG1 and then CG2, the total number of bits of the indication information is 5, and the first 2 bits are used for indicating the TOs from the CG1 and the next 3 bits are used for indicating the TOs from the CG2.

In some examples, the indication information may include, based on the first embodiment of the number of bits of the indication information as described above, a plurality of fields, each of the plurality of fields corresponding to each of the one or more CG configurations and indicating the usage state of the TO in the corresponding CG configuration. If the number of bits is M, and there are N CG configurations, then there could be M/N bits for each CG configurations. Attentively, there could be

$$⌊ \frac{M}{N} ⌋$$

bits for first CG to the N−1th CG, and

$$N - ( N - 1 ) ⌊ \frac{M}{N} ⌋$$

bits for last CG. For example, if the number of bits for one CG is not enough to indicate the usage of the TOs for the CG configuration, then the TOs can be divided into multiple sub-groups based on the embodiments as mentioned above in the present disclosure. For example, in the case as shown in FIG. 3A, there are two CG configurations CG1 and CG2, and four TOs from the CG1 and eight TOs from the CG2 are within in a single time domain window. If the number of bits of the indication information is 8 bits, then there could be 4 bits for each CG configuration. If the usage state of TOs is indicated by a bitmap, and 4 bits is not enough for the indication for CG2, then eight TOs for CG2 could be divided into 4 sub-groups, and 1 bit is used to indicate the usage state of TOs in a sub-group.

In some examples, the TOs are indexed in the pre-defined order, and the pre-defined order comprises at least one of the following: (6-1) an increasing order of a starting position or an ending position in time domain; (6-2) an increasing order of CG configuration index of the one or more CG configurations; (6-3) an increasing order of a length of TO; or (6-4) an increasing order of frequency domain resource block index of TO. It is understood that these orders of the indexed TOs are for example without suggesting any limitation, and these orders can also be combined in any sequence and in any number.

FIG. 5 illustrates a flowchart of an example method implemented at a terminal device in accordance with some embodiments of the present disclosure. For the purpose of discussion, the method 500 will be described from the perspective of the terminal device 120 with reference to FIG. 1.

At block 510, the terminal device 120 determines a group of TOs associated with the one or more CG configurations. At block 520, the terminal device 120 transmits, to the network device 110, indication information indicating a usage state of at least one TO in the group of TOs.

In some example embodiments, the terminal device 120 determines the group of TOs based on a time domain window. In some example embodiments, the terminal device 120 determines multiple configured TOs associated with the one or more configured CG configurations, wherein the group of TOs is the configured TOs located within the time domain window.

In some example embodiments, if a configured TO of the multiple configured TOs is cross the time domain window and a next time domain window, the configured TO being counted in one of the time domain window and the next time domain window; or any configured TO of the multiple configured TOs is located within a single time domain window. In some example embodiments, the length of the time domain window is based on a periodicity associated with the one or more CG configurations.

In some example embodiments, the length of the time domain window is equal to: a periodicity of one of the one or more CG configurations; a periodicity of a single CG configuration, the group of TOs being associated with the single CG configuration; a maximum periodicity among the one or more CG configurations; or a maximum periodicity among one of a plurality of groups divided from the one or more CG configurations, each of the plurality of groups comprising at least one CG configuration from the one or more CG configurations. In some example embodiments, the terminal device 120 identifies, based on at least one of a CG configuration index or a group index, that a plurality of CG configurations of the one or more CG configurations are in a same group of the plurality of groups.

In some example embodiments, a length of the time domain window is indicated by the network device 110 separately from the periodicity of the CG configuration. In some example embodiments, the time domain window is based on a time domain position of the indication information. In some example embodiments, a starting positioning of the time domain window is: a time domain position being the N-th time unit after a starting positioning or an ending positioning of the indication information, wherein N is a positive integer.

In some example embodiments, the time domain window is a time domain window in which the indication information is transmitted, among a plurality of time domain windows. In some example embodiments, the plurality of time domain windows are continuous in time domain, and the starting positioning of the earliest time domain window among the plurality of time domain windows is one of the following: a positioning indicated by the network device; a pre-defined positioning; a starting positioning of the earliest periodicity or the earliest TO of the one or more CG configurations; or a starting positioning of the earliest periodicity or the earliest TO of one of a plurality of groups divided from all of the one or more CG configurations, each of the plurality of groups comprising at least one CG configuration from the one or more CG configurations.

In some example embodiments, the terminal device 120 determines the groups of TO based on a pre-defined or indicated number of TOs. In some example embodiments, the earliest TO in the group of the TOs is based on a time domain position in which the indication information is transmitted. In some example embodiments, the earliest TO in the group of TOs is one of: the N-th time unit after the time domain position in which the indication information is transmitted, wherein N is a positive integer; or the earliest TO subsequent to the N-th time unit after the time domain position in which the indication information is transmitted, wherein N is a positive integer.

In some example embodiments, the group of TOs is a group of TOs in which the indication information is transmitted, among a plurality of continuous groups of TOs. In some example embodiments, the earliest TO of the earliest group of TOs among the plurality of continuous groups of TOs is one of the following: a TO indicated by the network device; a pre-defined TO; the earliest TO of the one or more CG configurations; or the earliest TO of one of a plurality of groups divided from all of the one or more CG configurations, each of the plurality of groups comprising at least one CG configuration from the one or more CG configurations.

In some example embodiments, the terminal device 120 determines multiple configured TOs associated with the one or more CG configurations, and the multiple configured TOs are indexed in a pre-defined order.

In some example embodiments, the terminal device 120 transmits indication information indicating a usage state of valid TO(s) in the group of TOs; or transmits indication information indicating a TO is unused, if the TO is invalid; or determines that the group of TOs only includes valid TO(s), wherein a TO is invalid if the TO is overlapped with a common downlink symbol, a dedicated downlink symbol, or a Synchronization Signal/Physical Broadcast Channel block.

In some example embodiments, the number of bits of the indication information is indicated by the network device. In some example embodiments, the number of bits of the indication information is based on a set of values configured by the network device, wherein a value indicates a number of unused TOs.

In some example embodiments, the set of values includes at least one negative value, a negative value indicating a necessary number of TO or indicating that TO is not enough.

In some example embodiments, the number of bits of the indication information is based on one of: a number of TOs in the group of TOs; or a maximum number of the TOs in all the time domain windows.

In some example embodiments, the number of bits of the indication information is based on a number of remaining TOs subsequent to the information indication in the group of TOs.

In some example embodiments, the indication information indicating a usage state of at least one TO in the group of TOs includes: indicating a number K indicating the usage state of the first K TOs or the last K TOs in the group of TOs, wherein K is a positive integer and the number of K is expressed by the number of bits of the indication information.

In some example embodiments, the indication information indicating a usage state of at least one TO in the group of TOs includes: the indication information being a bitmap, each bit of the bitmap indicating the usage state of a TO or sub-group of the TOs in the group of the TOs.

In some example embodiments, the indication information indicating a usage state of at least one TO in the group of TOs includes: the indication information indicating a starting index of TO and an ending index of TO, to indicate the usage state of TOs from the starting index of TO to the ending index of TO; or the indication information indicating a starting index of TO and a number of TOs, to indicate the usage state of TOs with the number of TOs from the starting index of TO.

In some example embodiments, the indication information indicating a usage state of at least one TO in the group of TOs includes: the indication information including a plurality of fields, each of the plurality of fields corresponding to each of the one or more CG configurations and indicating the usage state of the TO in the corresponding CG configuration. In some example embodiments, the fields in the indication information correspond to an increasing order of CG configuration index.

In some example embodiments, the TOs are indexed in the pre-defined order, and the pre-defined order comprises at least one of the following: an increasing order of a starting position or an ending position in time domain; an increasing order of CG configuration index of the one or more CG configurations; an increasing order of a length of TO; or an increasing order of frequency domain resource block index of TO.

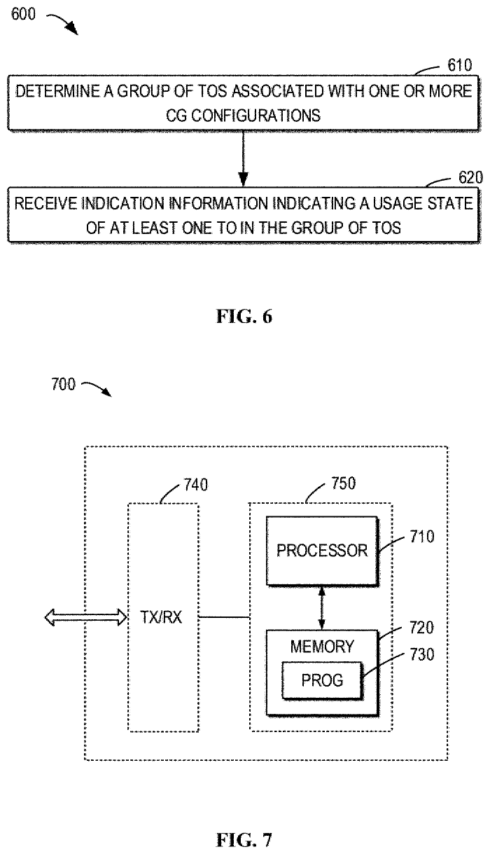

FIG. 6 illustrates a flowchart of an example method implemented at a network device in accordance with some embodiments of the present disclosure. For the purpose of discussion, the method 600 will be described from the perspective of the terminal device 110 with reference to FIG. 1.

At block 610, the network device 110 determines a group of TOs associated with one or more CG configurations. At block 620, the network device 110 receives, from the terminal device, indication information indicating a usage state of the at least one TO in the group of TOs.

In some example embodiments, the network device 110 configures the terminal 120 a time domain window, such that the terminal device 120 determines multiple configured TOs associated with the one or more configured CG configurations, wherein the group of TOs is the configured TOs located within the time domain window.

In some example embodiments, if a configured TO of the multiple configured TOs is cross the time domain window and a next time domain window, the configured TO being counted in one of the time domain window and the next time domain window; or any configured TO of the multiple configured TOs is located within a single time domain window. In some example embodiments, the length of the time domain window is based on a periodicity associated with the one or more CG configurations.

In some example embodiments, the length of the time domain window is equal to: a periodicity of one of the one or more CG configurations; a periodicity of a single CG configuration, the group of TOs being associated with the single CG configuration; a maximum periodicity among the one or more CG configurations; or a maximum periodicity among one of a plurality of groups divided from the one or more CG configurations, each of the plurality of groups comprising at least one CG configuration from the one or more CG configurations. In some example embodiments, at least one of a CG configuration index or a group index is used for determining that a plurality of CG configurations of the one or more CG configurations are in a same group of the plurality of groups is based on.

In some example embodiments, a length of the time domain window is indicated by the network device 110 separately from the periodicity of the CG configuration. In some example embodiments, the time domain window is based on a time domain position of the indication information. In some example embodiments, a starting positioning of the time domain window is: a time domain position being the N-th time unit after a starting positioning or an ending positioning of the indication information, wherein N is a positive integer.

In some example embodiments, the time domain window is a time domain window in which the indication information is transmitted, among a plurality of time domain windows. In some example embodiments, the plurality of time domain windows are continuous in time domain, and the starting positioning of the earliest time domain window among the plurality of time domain windows is one of the following: a positioning indicated by the network device; a pre-defined positioning; a starting positioning of the earliest periodicity or the earliest TO of the one or more CG configurations; or a starting positioning of the earliest periodicity or the earliest TO of one of a plurality of groups divided from all of the one or more CG configurations, each of the plurality of groups comprising at least one CG configuration from the one or more CG configurations.

In some example embodiments, the network device 110 configures the terminal device 120 a number of TOs for determining the groups of TO. In some example embodiments, the earliest TO in the group of the TOs is based on a time domain position in which the indication information is transmitted. In some example embodiments, the earliest TO in the group of TOs is one of: the N-th time unit after the time domain position in which the indication information is transmitted, wherein N is a positive integer; or the earliest TO subsequent to the N-th time unit after the time domain position in which the indication information is transmitted, wherein N is a positive integer.

In some example embodiments, the group of TOs is a group of TOs in which the indication information is transmitted, among a plurality of continuous groups of TOs. In some example embodiments, the earliest TO of the earliest group of TOs among the plurality of continuous groups of TOs is a TO indicated by the network device 120.

In some example embodiments, the multiple configured TOs are associated with the one or more CG configurations and indexed in a pre-defined order.

In some example embodiments, the network device 110 receives, from the terminal device 120, indication information indicating a usage state of valid TO(s) in the group of TOs; or receives indication information indicating a TO is unused, if the TO is invalid; or is informed that the group of TOs only includes valid TO(s), wherein a TO is invalid if the TO is overlapped with a common downlink symbol, a dedicated downlink symbol, or a Synchronization Signal/Physical Broadcast Channel block.

In some example embodiments, the number of bits of the indication information is indicated by the network device. In some example embodiments, the number of bits of the indication information is based on a set of values configured by the network device, wherein a value indicates a number of unused TOs.

In some example embodiments, the set of values includes at least one negative value, a negative value indicating a necessary number of TO or indicating that TO is not enough.

In some example embodiments, the number of bits of the indication information is based on one of: a number of TOs in the group of TOs; or a maximum number of the TOs in all the time domain windows.

In some example embodiments, the number of bits of the indication information is based on a number of remaining TOs subsequent to the information indication in the group of TOs.

In some example embodiments, the indication information indicating a usage state of at least one TO in the group of TOs includes: indicating a number K indicating the usage state of the first K TOs or the last K TOs in the group of TOs, wherein K is a positive integer and the number of K is expressed by the number of bits of the indication information.

In some example embodiments, the indication information indicating a usage state of at least one TO in the group of TOs includes: the indication information being a bitmap, each bit of the bitmap indicating the usage state of a TO or sub-group of the TOs in the group of the TOs.

In some example embodiments, the indication information indicating a usage state of at least one TO in the group of TOs includes: the indication information indicating a starting index of TO and an ending index of TO, to indicate the usage state of TOs from the starting index of TO to the ending index of TO; or the indication information indicating a starting index of TO and a number of TOs, to indicate the usage state of TOs with the number of TOs from the starting index of TO.

In some example embodiments, the indication information indicating a usage state of at least one TO in the group of TOs includes: the indication information including a plurality of fields, each of the plurality of fields corresponding to each of the one or more CG configurations and indicating the usage state of the TO in the corresponding CG configuration. In some example embodiments, the fields in the indication information correspond to an increasing order of CG configuration index.

In some example embodiments, the TOs are indexed in the pre-defined order, and the pre-defined order comprises at least one of the following: an increasing order of a starting position or an ending position in time domain; an increasing order of CG configuration index of the one or more CG configurations; an increasing order of a length of TO; or an increasing order of frequency domain resource block index of TO.

FIG. 7 illustrates a simplified block diagram of a device 700 that is suitable for implementing embodiments of the present disclosure. The device 700 can be considered as a further example implementation of the terminal device 120, and the network device 110 as shown in FIG. 1. Accordingly, the device 700 can be implemented at or as at least a part of the terminal device 120, or the network device 110.

As shown, the device 700 includes a processor 710, a memory 720 coupled to the processor 710, a suitable transmitter (TX) and receiver (RX) 740 coupled to the processor 710, and a communication interface coupled to the TX/RX 740. The memory 710 stores at least a part of a program 730. The TX/RX 740 is for bidirectional communications. The TX/RX 740 has at least one antenna to facilitate communication, though in practice an Access Node mentioned in this disclosure may have several ones. The communication interface may represent any interface that is necessary for communication with other network elements, such as X2 interface for bidirectional communications between eNBs, S1 interface for communication between a Mobility Management Entity (MME)/Serving Gateway (S-GW) and the eNB, Un interface for communication between the eNB and a relay node (RN), or Uu interface for communication between the eNB and a terminal device.

The program 730 is assumed to include program instructions that, when executed by the associated processor 710, enable the device 700 to operate in accordance with the embodiments of the present disclosure, as discussed herein with reference to FIGS. 1-6. The embodiments herein may be implemented by computer software executable by the processor 710 of the device 700, or by hardware, or by a combination of software and hardware. The processor 710 may be configured to implement various embodiments of the present disclosure. Furthermore, a combination of the processor 710 and memory 720 may form processing means 750 adapted to implement various embodiments of the present disclosure.

The memory 720 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 720 is shown in the device 700, there may be several physically distinct memory modules in the device 700. The processor 710 may be of any type suitable to the local technical network, and may include one or more of general purpose computers, special purpose computers, microprocessors, digital signal processors (DSPs) and processors based on multicore processor architecture, as non-limiting examples. The device 700 may have multiple processors, such as an application specific integrated circuit chip that is slaved in time to a clock which synchronizes the main processor.

In summary, embodiments of the present disclosure may provide the following solutions.

Clause 1. A terminal device comprising: a processor; and a transceiver coupled to the processor, wherein the processor is configured to: determine a group of transmission occasions (TOs) associated with one or more configured grant (CG) configurations; and transmit, via the transceiver, to a network device, indication information indicating a usage state of at least one TO in the group of TOs.

Clause 2. The terminal device of Clause 1, the processor is configured to determine the group of TOs based on a time domain window.

Clause 3. The terminal device of Clause 2, the processor is configured to
determine multiple configured TOs associated with the one or more configured CG configurations, wherein the group of TOs is the configured TOs located within the time domain window.

Clause 4. The terminal device of Clause 3, wherein: if a configured TO of the multiple configured TOs is cross the time domain window and a next time domain window, the configured TO being counted in one of the time domain window and the next time domain window; or any configured TO of the multiple configured TOs is located within a single time domain window.

Clause 5. The terminal device of Clause 2, wherein the length of the time domain window is based on a periodicity associated with the one or more CG configurations.

Clause 6. The terminal device of Clause 5, wherein the length of the time domain window is equal to: a periodicity of one of the one or more CG configurations; a periodicity of a single CG configuration, the group of TOs being associated with the single CG configuration; a maximum periodicity among the one or more CG configurations; or a maximum periodicity among one of a plurality of groups divided from the one or more CG configurations, each of the plurality of groups comprising at least one CG configuration from the one or more CG configurations.

Clause 7. The terminal device of Clause 6, wherein the processor is further configured to: identify, based on at least one of a CG configuration index or a group index, that a plurality of CG configurations of the one or more CG configurations are in a same group of the plurality of groups.

Clause 8. The terminal device of Clause 2 or 3, wherein a length of the time domain window is indicated by the network device separately from the periodicity of the CG configuration.

Clause 9. The terminal device of any of Clause 2, wherein the time domain window is based on a time domain position of the indication information.

Clause 10. The terminal device of Clause 9, wherein a starting positioning of the time domain window is: a time domain position being the N-th time unit after a starting positioning or an ending positioning of the indication information, wherein N is a positive integer.

Clause 11. The terminal device of Clause 9, wherein the time domain window is a time domain window in which the indication information is transmitted, among a plurality of time domain windows.

Clause 12. The terminal device of Clause 11, wherein the plurality of time domain windows are continuous in time domain, and the starting positioning of the earliest time domain window among the plurality of time domain windows is one of the following: a positioning indicated by the network device; a pre-defined positioning; a starting positioning of the earliest periodicity or the earliest TO of the one or more CG configurations; or a starting positioning of the earliest periodicity or the earliest TO of one of a plurality of groups divided from all of the one or more CG configurations, each of the plurality of groups comprising at least one CG configuration from the one or more CG configurations.

Clause 13. The terminal device of Clause 1, the processor is configured to determine the groups of TO based on a pre-defined or indicated number of TOs.

Clause 14. The terminal device of any of Clauses 13, wherein the earliest TO in the group of the TOs is based on a time domain position in which the indication information is transmitted.

Clause 15. The terminal device of Clause 14, wherein the earliest TO in the group of TOs is one of: the N-th time unit after the time domain position in which the indication information is transmitted, wherein N is a positive integer; or the earliest TO subsequent to the N-th time unit after the time domain position in which the indication information is transmitted, wherein N is a positive integer.

Clause 16. The terminal device of Clause 14, wherein the group of TOs is a group of TOs in which the indication information is transmitted, among a plurality of continuous groups of TOs.

Clause 17. The terminal device of Clause 16, wherein the earliest TO of the earliest group of TOs among the plurality of continuous groups of TOs is one of the following: a TO indicated by the network device; a pre-defined TO; the earliest TO of the one or more CG configurations; or the earliest TO of one of a plurality of groups divided from all of the one or more CG configurations, each of the plurality of groups comprising at least one CG configuration from the one or more CG configurations.

Clause 18. The terminal device of any of Clause 13, wherein the processor is configured to: determine multiple configured TOs associated with the one or more CG configurations, and the multiple configured TOs are indexed in a pre-defined order.

Clause 19. The terminal device of Clause 1, wherein the processor is configured to: transmit indication information indicating a usage state of valid TO(s) in the group of TOs; transmit indication information indicating a TO is unused, if the TO is invalid; or determine that the group of TOs only includes valid TO(s); wherein a TO is invalid if the TO is overlapped with a common downlink symbol, a dedicated downlink symbol, or a symbol for Synchronization Signal/Physical Broadcast Channel block.

Clause 20. The terminal device of Clause 1, wherein the number of bits of the indication information is indicated by the network device.

Clause 21. The terminal device of Clause 20, wherein the number of bits of the indication information is based on a set of values configured by the network device, wherein a value indicates a number of unused TOs.

Clause 22. The terminal device of Clause 21, wherein the set of values includes at least one negative value, a negative value indicating a necessary number of TO or indicating that TO is not enough.

Clause 23. The terminal device of Clause 1, wherein the number of bits of the indication information is based on one of: a number of TOs in the group of TOs; or a maximum number of the TOs in all the time domain windows.

Clause 24. The terminal device of Clause 1, wherein the number of bits of the indication information is based on a number of remaining TOs subsequent to the information indication in the group of TOs.

Clause 25. The terminal device of any of Clauses 20-24, wherein the indication information indicating a usage state of at least one TO in the group of TOs includes: indicating a number K indicating the usage state of the first K TOs or the last K TOs in the group of TOs, wherein K is a positive integer and the number of K is expressed by the number of bits of the indication information.

Clause 26. The terminal device of Clause 20 or 23, wherein the indication information indicating a usage state of at least one TO in the group of TOs includes: the indication information being a bitmap, each bit of the bitmap indicating the usage state of a TO or sub-group of the TOs in the group of the TOs.

Clause 27. The terminal device of Clause 23 or 24, wherein the indication information indicating a usage state of at least one TO in the group of TOs includes: the indication information indicating a starting index of TO and an ending index of TO, to indicate the usage state of TOs from the starting index of TO to the ending index of TO; or the indication information indicating a starting index of TO and a number of TOs, to indicate the usage state of TOs with the number of TOs from the starting index of TO.

Clause 28. The terminal device of Clause 20, wherein the indication information indicating a usage state of at least one TO in the group of TOs includes: the indication information including a plurality of fields, each of the plurality of fields corresponding to each of the one or more CG configurations and indicating the usage state of the TO in the corresponding CG configuration.

Clause 29. The terminal device of Clause 28, the fields in the indication information correspond to an increasing order of CG configuration index.

Clause 30. The terminal device of any of Clauses 13-19 or 25-29, wherein the TOs are indexed in the pre-defined order, and the pre-defined order comprises at least one of the following: an increasing order of a starting position or an ending position in time domain; an increasing order of CG configuration index of the one or more CG configurations; an increasing order of a length of TO; or an increasing order of frequency domain resource block index of TO.

Clause 31. A network device comprising: a processor; and a transceiver coupled to the processor, wherein the processor is configured to: determine, via the processor, a group of transmission occasions (TOs) associated with one or more configured grant (CG) configurations; and receive, via the transceiver, from the terminal device, indication information indicating a usage state of the at least one TO in the group of TOs.

Clause 32. A method performed by a terminal device, comprising: determining a group of transmission occasions (TOs) associated with one or more configured grant (CG) configurations; and transmitting, to a network device, indication information indicating a usage state of at least one TO in the group of TOs.

Clause 33. A method performed by a network device, comprising: determining a group of transmission occasions (TOs) associated with one or more configured grant (CG) configurations; and receiving, from the terminal device, indication information indicating a usage state of the at least one TO in the group of TOs.

Clause 34. A computer readable medium having instructions stored thereon, which, when executed on at least one processor of a device, causing the device to perform the method according to Clause 32.

Clause 35. A computer readable medium having instructions stored thereon, which, when executed on at least one processor of a device, causing the device to perform the method according to Clause 33.

Through the solution of the present disclosure, a signaling mechanism can be introduced which allows the terminal device to indicate the network device the usage state of TO such that the network device can adjust subsequent resource allocation to avoid waste of unused TOs, thereby improving the performance of the communication. The particular designs on the format of indication information in the present disclosure contributes to save signaling overhead, for example, by adopting limited number of bits to indicate the usage of TOs associated with one or more CG configurations.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1. A user equipment (UE), comprising:
at least one memory; and
at least one processor coupled with the at least one memory and configured to cause the UE to:
determine a group of transmission occasions (TOs) associated with one or more configured grant (CG) configurations; and
transmit to a base station, indication information indicating a usage state of at least one TO in the group of TOs.

2. The UE of claim 1, wherein the at least one processor is configured to cause the UE to determine the group of TOs based on a time domain window.

3. The UE of claim 2, wherein the at least one processor is configured to cause the UE to determine multiple configured TOs associated with the one or more configured CG configurations, wherein the group of TOs is the configured TOs located within the time domain window.

4. The UE of claim 2, wherein a length of the time domain window is based on a periodicity associated with the one or more CG configurations.

5. The UE of claim 2, wherein the time domain window is based on a time domain position of the indication information.

6. The UE of claim 5, wherein a starting positioning of the time domain window is:
a time domain position being an N-th time unit after a starting positioning or an ending positioning of the indication information, wherein N is a positive integer.

7. The UE of claim 5, wherein the time domain window is a time domain window in which the indication information is transmitted, among a plurality of time domain windows.

8. The UE of claim 1, wherein the at least one processor is configured to cause the UE to:
transmit indication information indicating a usage state of valid TO(s) in the group of TOs; or
transmit indication information indicating a TO is unused, if the TO is invalid; or determine that the group of TOs only includes valid TO(s);
wherein a TO is invalid if the TO is overlapped with a common downlink symbol, a dedicated downlink symbol, or a symbol for Synchronization Signal/Physical Broadcast Channel (SS/PBCH) block.

9. The UE of claim 1, wherein a number of bits of the indication information is indicated by the base station.

10. The UE of claim 1, wherein a number of bits of the indication information is based on one of:
a number of TOs in the group of TOs; or
a maximum number of the TOs in all time domain windows.

11. The UE of claim 1, wherein a number of bits of the indication information is based on a number of remaining TOs subsequent to the information indication in the group of TOs.

12. The UE of claim 10, wherein the indication information indicating a usage state of at least one TO in the group of TOs includes:
the indication information indicating a starting index of TO and an ending index of TO, to indicate the usage state of TOs from the starting index of TO to the ending index of TO; or
the indication information indicating a starting index of TO and a number of TOs, to indicate the usage state of TOs with the number of TOs from the starting index of TO.

13. The UE of claim 9, wherein the indication information indicating a usage state of at least one TO in the group of TOs includes:
the indication information including a plurality of fields, each of the plurality of fields corresponding to each of the one or more CG configurations and indicating the usage state of the TO in the corresponding CG configuration.

14. A base station, comprising:
at least one memory; and
at least one processor coupled with the at least one memory and configured to cause the base station to:
determine a group of transmission occasions (TOs) associated with one or more configured grant (CG) configurations; and
receive from a base station, indication information indicating a usage state of the at least one TO in the group of TOs.

15. A method performed by a user equipment (UE), comprising:
determining a group of transmission occasions (TOs) associated with one or more configured grant (CG) configurations; and
transmitting, to a base station, indication information indicating a usage state of at least one TO in the group of TOs.

16. A processor for wireless communication, comprising:
at least one controller coupled with at least one memory and configured to cause the processor to:
determine a group of transmission occasions (TOs) associated with one or more configured grant (CG) configurations; and
transmit to a base station, indication information indicating a usage state of at least one TO in the group of TOs.

17. The processor of claim 16, wherein the at least one controller is configured to cause the processor to determine the group of TOs based on a time domain window.

18. The processor of claim 17, wherein the at least one controller is configured to cause the processor to determine multiple configured TOs associated with the one or more configured CG configurations, wherein the group of TOs is the configured TOs located within the time domain window.

19. The UE of claim 1, wherein the at least one processor is configured to cause the UE to determine the group of TOs based on a predefined or indicated number of TOs in the group of TOs.

20. The UE of claim 19, wherein the time domain window is determined based on a time domain position in which the indication information is transmitted.
